(19) United States
(12) Patent Application Publication
(10) Pub. No.: US 2026/0046657 A1
(43) Pub. Date: Feb. 12, 2026

(54) METHOD AND APPARATUS FOR MINIMIZATION OF DRIVE TESTS MEASUREMENT ENHANCEMENT

(71) Applicant: SAMSUNG ELECTRONICS CO., LTD., Suwon-si, Gyeonggi-do (KR)

(72) Inventors: Hong WANG, Beijing (CN); Lixiang XU, Beijing (CN); Weiwei WANG, Beijing (CN)

(21) Appl. No.: 18/998,458

(22) PCT Filed: Jul. 27, 2023
(86) PCT No.: PCT/KR2023/010921

§ 371 Date: Jan. 24, 2025

(30) Foreign Application Priority Data
Jul. 28, 2022 (CN) 202210901835.9

(51) Int. Cl. H04W 24/10; H04W 24/08; H04W 76/27

(52) U.S. Cl. CPC H04W 24/10; H04W 24/08; H04W 76/27

(57) ABSTRACT

The disclosure relates to a 5G or 6G communication system for supporting a higher data transmission rate. The present invention provides a method and a device for minimization of drive tests measurement enhancement. The method includes receiving at least one indication information of first indication information, second indication information and third indication information from a first node, wherein the first indication information indicates whether a MDT measurement result exists, the second indication information indicates whether a MDT measurement configuration exists, and the third indication information indicates an access network technology. The present invention can prevent the management-based minimization of drive tests from covering the signaling-based minimization of drive tests, or the management-based minimization of drive tests can be configured in time.

### TECHNICAL FIELD

The present invention relates to generally to wireless communication technology, and more specifically, the present disclosure relates to a method and an apparatus for minimization of drive tests measurement enhancement.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and an apparatus for minimization of drive tests measurement enhancement.

### Solution to Problem

According to various embodiments of the present invention, a method for minimization of drive tests MDT measurement enhancement performed by a second node is provided, may include receiving at least one indication information of first indication information, second indication information and third indication information from a first node, wherein the first indication information indicates whether an MDT measurement result exists, the second indication information indicates whether an MDT measurement configuration exists, and the third indication information indicates an access network technology.

In some implementations, the first indication information indicates at least one of: a logged measurement result existing; a logged measurement result in a first access mode existing; a logged measurement result in a second access mode existing.

In some implementations, the second indication information indicates at least one of: a signaling-based logged configuration existing; a management-based logged configuration existing; a signaling-based logged configuration in a first access mode existing; a management-based logged configuration in the first access mode existing; a signaling-based logged configuration in a second access mode existing; a management-based logged configuration in the second access mode existing.

In some implementations, the third indication information indicates at least one of Long Term Evolution LTE technology, Evolved Universal Mobile Telecommunications System UMTS Terrestrial Radio Access EUTRA, Fifth Generation 5G communication technology and New Access NR technology.

In some implementations, the method may further include at least one of: in a case that the first indication information and/or the third indication information indicates that a logged measurement result in a first access mode exists, if the second node is a node in the first access mode, requesting a first node to report the logged measurement result, and if the second node is a node in a second access mode, forwarding the at least one indication information to a third node; in a case that the first indication information and/or the second indication information and/or the third indication information indicates that the logged measurement result in the first access mode exists and a signaling-based logged configuration in the first access mode exists, if the second node is the node in the second access mode, another MDT being not configured; and in a case that the first indication information and/or the second indication information and/or the third indication information indicates that the logged measurement result in the first access mode does not exist and the signaling-based logged configuration in the first access mode exists, if the second node is the node in the second access mode, another MDT being able to be configured.

In some implementations, the at least one indication information is received from the first node through a Radio Resource Control RRC message.

According to various embodiments of the present invention, a method for minimization of drive tests MDT measurement enhancement performed by a third node is provided, may include receiving at least one indication information of first indication information, second indication information and third indication information from a second node, wherein the at least one indication information is received by the second node from a first node, wherein the first indication information indicates whether an MDT measurement result exists, the second indication information indicates whether an MDT measurement configuration exists, and the third indication information indicates an access network technology.

In some implementations, the first indication information indicates at least one of: a logged measurement result existing; a logged measurement result in a first access mode existing; a logged measurement result in a second access mode existing.

In some implementations, the second indication information indicates at least one of: a signaling-based logged configuration existing; a management-based logged configuration existing; a signaling-based logged configuration in a first access mode existing; a management-based logged configuration in the first access mode existing; a signaling-based logged configuration in a second access mode existing; a management-based logged configuration in the second access mode existing.

In some implementations, the third indication information indicates at least one of Long Term Evolution LTE technology, Evolved Universal Mobile Telecommunications System UMTS Terrestrial Radio Access EUTRA, Fifth Generation 5G communication technology and New Access NR technology.

In some implementations, the at least one indication information is received from the second node through a secondary base station addition request message or through a Radio Resource Control RRC container, wherein the RRC container includes at least one of the first indication information, the second indication information and the third indication information.

In some implementations, the method may further include transmitting a first Radio Resource Control RRC message to the first node to request the first node to report a logged measurement result.

In some implementations, the first RRC message is transmitted directly to the first node through a signaling radio bearer or forwarded to the first node through the second node.

In some implementations, the method may further include receiving a second RRC message from the first node, wherein the second RRC message carries the logged measurement result.

In some implementations, the second RRC message is received directly from the first node through a signaling radio bearer, or the second RRC message is received from the second node, wherein the second RRC message is received by the second node from the first node.

In some implementations, the second node and/or the third node may include a Centralized Unit-Control Plane CU-CP, a Centralized Unit-User Plane CU-UP and a Distributed Unit DU, and the receiving of the at least one indication information comprises receiving, by the CU-CP, the at least one indication information, and wherein the method further includes: transmitting, by the CU-CP, a first request message to the CU-UP, wherein the first request message includes the at least one indication information; transmitting, by the CU-UP, a first response message to the CU-CP; transmitting, by the CU-CP, a second request message to the DU, wherein the second request message includes the at least one indication information; and transmitting, by the DU, a second response message to the CU-CP.

According to various embodiments of the present invention, a method for minimization of drive tests MDT measurement enhancement performed by a first node is provided, may include transmitting at least one indication information of first indication information, second indication information and third indication information to a second node, wherein the first indication information indicates whether an MDT measurement result exists, the second indication information indicates whether an MDT measurement configuration exists, and the third indication information indicates an access network technology.

In some implementations, the first indication information indicates at least one of: a logged measurement result existing; a logged measurement result in a first access mode existing; a logged measurement result in a second access mode existing.

In some implementations, the second indication information indicates at least one of: a signaling-based logged configuration existing; a management-based logged configuration existing; a signaling-based logged configuration in a first access mode existing; a management-based logged configuration in the first access mode existing; a signaling-based logged configuration in a second access mode existing; a management-based logged configuration in the second access mode existing.

In some implementations, the third indication information indicates at least one of Long Term Evolution LTE technology, Evolved Universal Mobile Telecommunications System UMTS Terrestrial Radio Access EUTRA, Fifth Generation 5G communication technology and New Access NR technology.

In some implementations, the at least one indication information is transmitted to the second node through a Radio Resource Control RRC message.

In some implementations, the method may further include receiving a first Radio Resource Control RRC message from a third node, wherein the first RRC message is used to request the first node to report a logged measurement result.

In some implementations, the first RRC message is received directly from the third node through a signaling radio bearer, or the first RRC message is received from the second node, wherein the first RRC message is received by the second node from the third node.

In some implementations, the method may further include transmitting a second RRC message to the third node, wherein the second RRC message carries the logged measurement result.

In some implementations, the second RRC message is transmitted directly to the third node through a signaling radio bearer, or forwarded to the third node through the second node.

According to various embodiments of the present invention, a second node is provided, may include a transceiver configured to transmit and receive signals; and a controller coupled with the transceiver and configured to perform the aforementioned methods.

According to various embodiments of the present invention, a third node is provided, may include a transceiver configured to transmit and receive signals; and a controller coupled with the transceiver and configured to perform the aforementioned methods.

According to various embodiments of the present invention, a first node is provided, may include a transceiver configured to transmit and receive signals; and a controller coupled with the transceiver and configured to perform the aforementioned methods.

The present invention provides a method and a device for minimization of drive tests measurement enhancement. Through the method for enhanced minimization of drive tests, it can prevent the management-based minimization of drive tests from covering the signaling-based minimization of drive tests, or the management-based minimization of drive tests can be configured in time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and an apparatus for minimization of drive tests measurement enhancement.

### BRIEF DESCRIPTION OF DRAWINGS

In order to illustrate the technical solution of embodiments of the present disclosure more clearly, the drawings of the embodiments will be briefly introduced below, and apparently, the drawings in the following description only relate to some embodiments of the present disclosure, but do not limit the present disclosure. In the drawings:

FIG. 1 is an exemplary system architecture of system architecture evolution (SAE);

FIG. 2 is an exemplary system architecture according to various embodiments of the present disclosure;

FIG. 3 illustrates a structural diagram of a management-based MDT;

FIG. 4 illustrates a flowchart of a method according to various embodiments of the present disclosure;

FIG. 5 illustrates a flowchart of a method according to various embodiments of the present disclosure;

FIG. 6 illustrates a flowchart of a method according to various embodiments of the present disclosure;

FIG. 7 illustrates a flowchart of a method according to various embodiments of the present disclosure;

FIG. 8 illustrates a flowchart of a method according to various embodiments of the present disclosure; and

FIG. 9 illustrates a block diagram of a configuration of a node according to various embodiments of the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

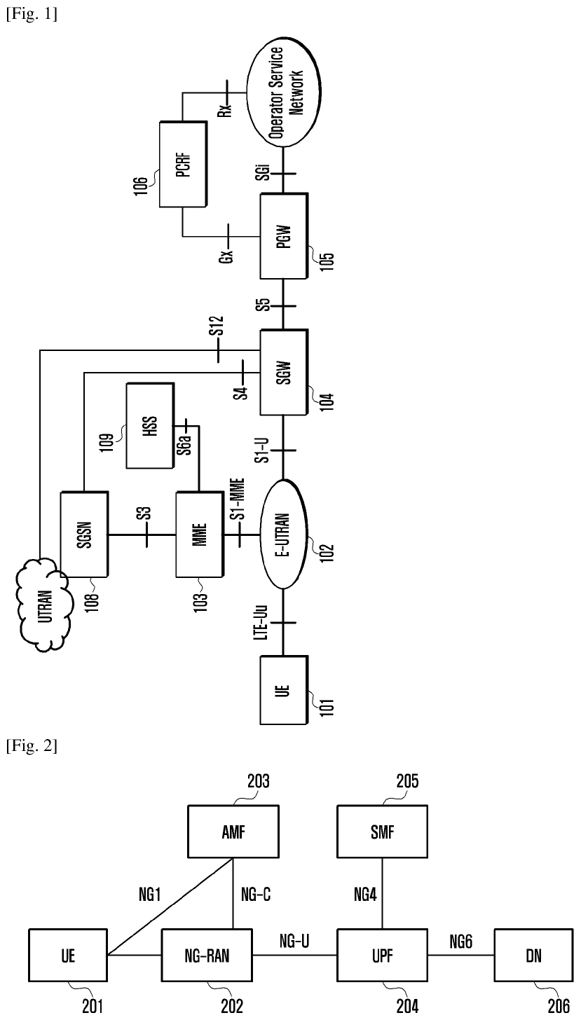

FIGS. 1 to 9 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Throughout the specification, references to “one embodiment”, “an embodiment”, “one example” or “an example” mean that a specific feature, structure or characteristic described in connection with the embodiment or example is included in at least one embodiment of the present disclosure. Therefore, the phrases “in one embodiment”, “in an embodiment”, “one example” or “an example” in various places throughout the specification do not necessarily all refer to the same embodiment or example. Furthermore, specific features, structures or characteristics may be combined in one or more embodiments or examples with any suitable combination and/or sub-combination. Furthermore, it should be understood by those skilled in the art that the drawings provided herein are for illustration purposes and are not necessarily drawn to scale. The term “and/or” used herein includes any and all combinations of one or more related listed items.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

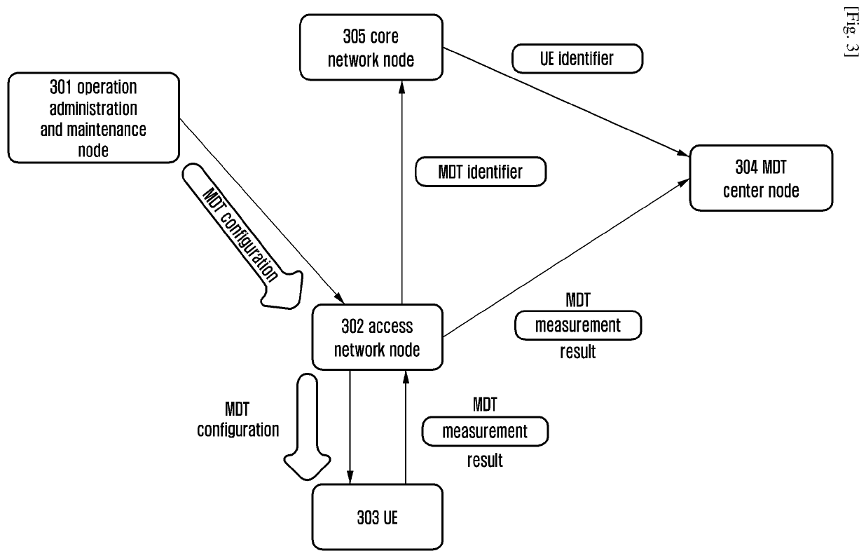

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. An interface between the AMF and the NG-RAN is called an NG-C interface, or an NG interface or an N2 interface. An interface between the UPF and the NG-RAN is called an NG-U interface, or an N3 interface, and signaling between the UE and the AMF is called Non-Access Stratum (NAS) signaling, also called an N1 interface. An interface between base stations is called an Xn interface.

Minimization of drive tests (MDT) is to make base stations or users perform some measurements and transmit measurement results to a measurement center node, such as TCE (Trace Collection Entity) node, so as to reduce the burden of manual testing. MDT measurement should support real-time and non-real-time measurement. A core network or operation administration and maintenance node transmits an MDT activation message to an access network node, which carries a specific MDT measurement configuration, such as measurement type, measurement cycle, threshold, reporting cycle or threshold, etc. Some MDT measurement types require a UE to measure. For these measurement types, the access network node transmits a radio resource control (RRC) message to the UE, configures the UE to perform MDT measurement, and the UE reports a measurement result to the access network node. Some MDT measurement types require a base station to measure. For these measurement types, the base station performs MDT measurement according to specific configuration information. The access network transmits the measurement result, including the measurement result by the UE and the measurement result by the base station, to the measurement center node.

According to the way in which MDT is initiated, MDT can be divided into management-based MDT and signaling-based MDT. The management-based MDT means that an access network entity receives the MDT activation message from the operation administration and maintenance node, and the signaling-based MDT means that the access network entity receives the MDT activation message from a core network entity, such as a mobility management entity.

According to a state of the UE, the MDT measurement by the UE in an RRC-connected state is called immediate MDT, and the MDT measurement by the UE in an RRC-idle state or RRC-inactive state is called logged MDT.

In some cases, the management-based minimization of drive tests may cover the signaling-based minimization of drive tests, or the management-based minimization of drive tests is not configured in time, so a method for minimization of drive tests measurement enhancement is needed.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

FIG. 3 describes a structure diagram of management-based MDT. Reference numeral 301 denotes an Operation Administration and Maintenance (OAM) node, and the operation administration and maintenance node 301 transmits an MDT activation request message to an access network node 302, which may be an eNB of a 4G system or a gNB or an eNB of a 5G system, or a base station in other systems. The MDT activation request message includes MDT configuration information. The MDT configuration information mainly includes: MDT location selection condition, reporting mechanism configuration, Trace Reference (TR), IP address of MDT measurement center node (such as TCE), operation type, MDT data anonymity, etc. The above work types may be configured into different types, for example, at present, four types are defined: immediate MDT only, logged MDT only, trace only, immediate MDT and trace. Defining of more types or simplifying of types is not excluded. The MDT location selection condition configures UEs in which locations can be selected as users for MDT measurement. The location selection condition may be configured as a range of a cell, or a range of a TAC (Tracking Area Code), or the whole PLMN (Public Land Mobile Network). The UEs within the range can be selected as UEs for MDT. The TR uniquely identifies an MDT process. In an MDT process, the base station may select multiple users for MDT measurement.

The access network node 302 selects a UE for MDT measurement. When the access network node selects the UE, it must follow certain conditions, such as considering whether the user agrees to the measurement and/or whether the UE is located in an MDT location in the MDT configuration information. If the UE does not agree with the MDT or does not satisfy the location selection condition, the UE cannot be selected as the UE for MDT. After selecting the UE, the access network node transmits the MDT configuration information to the UE if the UE is required to perform measurement. The UE performs MDT measurement according to the configuration, and transmits a measurement result to the access network node when a reporting condition is satisfied. The access network node transmits an MDT tracking message to a core network entity 305, which may be a Mobility Management Entity (MME) of 4G, an AMF (Access and Mobility Management Function) of 5G, or a core network entity connected to an access network in other systems. The message includes at least an identification of MDT and an IP address of TCE. The core network entity 305 finds a unique identifier of the UE, such as IMSI (International Mobile Subscriber Identity) or IMEI (International Mobile Equipment Identity) (SV (Software Version)), and transmits the unique identifier to the TCE. The access network node 302 saves the MDT measurement result, also called MDT log, and according to a predefined policy, the access network node 302 transmits the MDT log to the TCE, and the TCE can know which UEs the MDT log is aimed at by combining the information transmitted by the core network entity.

The difference of signaling-based MDT is that an MDT initiation message is transmitted from the core network entity to the access network entity, and the MDT configuration information is allocated by the core network entity. A priority of the signaling-based MDT is relatively high. If the signaling-based MDT has been configured for a certain UE, the network can no longer configure the management-based MDT, to avoid that the management-based MDT covers the signaling-based MDT.

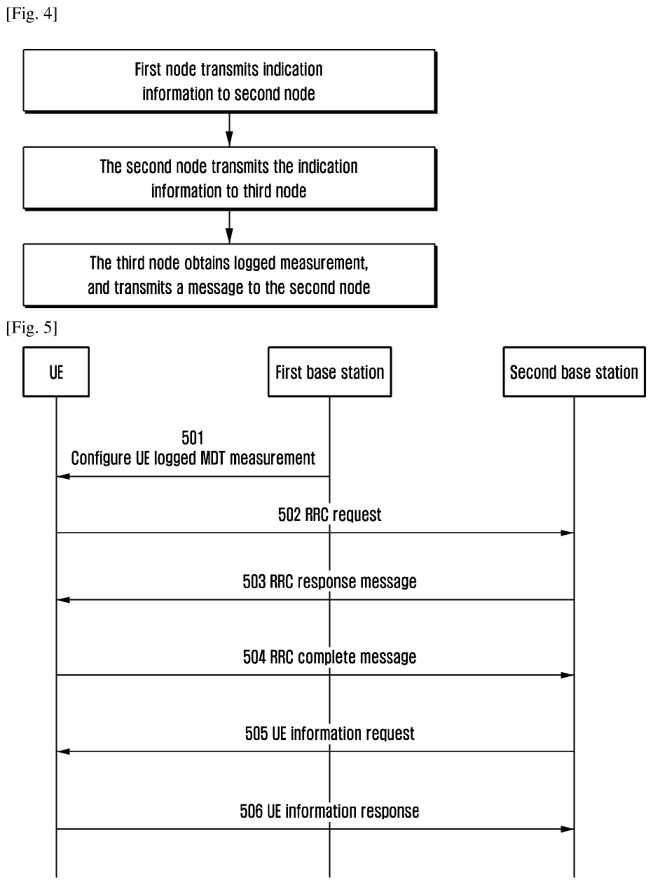

A schematic diagram of a method of the present invention is shown in FIG. 4. A first node transmits one or more of first indication information, second indication information and third indication information (access network technology indication in-formation) to a second node. The first indication information may be MDT measurement result existence, and the second indication information may be MDT measurement configuration existence.

The first indication information indicates whether an MDT measurement result exists, which may indicate one of the following cases:
a logged measurement result existing;
an immediate measurement result existing;
a logged measurement result in EUTRA existing;
an immediate measurement result in EUTRA existing;
a logged measurement result in NR existing;
an immediate measurement result in NR existing.

The second indication information indicates whether MDT measurement configuration is performed for the UE, which may indicate one of the following cases:
a signaling-based logged configuration existing;
a signaling-based immediate configuration existing;
a management-based logged configuration existing;
a management-based immediate configuration existing;
a signaling-based logged configuration in EUTRA existing;
a signaling-based immediate configuration in EUTRA existing;
a management-based logged configuration in EUTRA existing;
a management-based immediate configuration in EUTRA existing;
a signaling-based logged configuration in NR existing;
a signaling-based immediate configuration in NR existing;
a management-based logged configuration in NR existing;
a management-based immediate configuration in NR existing.

The access network technology indication information may be set as Long Term Evolution (LTE), Evolved UMTS Terrestrial Radio Access (EUTRA), Fifth Generation Communication (5G), New Access Technology (NR), etc.

The first node may be a terminal (UE), a base station (gNB, eNB or other base stations), a dual-connectivity primary base station (MN for short), a dual-connectivity secondary base station (SN for short), a core network node (CN for short). The second node may be a UE, a base station, a dual-connectivity primary base station, a dual-connectivity secondary base station, a core network node.

The second node performs a corresponding operation according to the indication information. The corresponding operation may be one of the following operations:
knowing that the UE has the logged measurement result in the EUTRA mode existed through the first indication information and/or the access network technology indication information. If the second node is a base station in the EUTRA mode, the second node may request the UE to report the logged measurement result. If the second node is a base station in the NR mode, the second node may forward the indication information to a third node, which is a base station in the EUTRA mode, and the third node requests the UE to report the logged measurement result. Alternatively, in different scenarios, the third node may be a UE, a base station, a dual-connectivity primary base station, a dual-connectivity secondary base station, a core network node.
knowing that the UE has the logged measurement result in the NR mode existed through the first indication information and/or the access network technology indication information. If the second node is a base station in the NR mode, the second node may request the UE to report the logged measurement result. If the second node is not the base station in the NR mode, for example, it is a base station in the EUTRA mode, the second node may forward the indication information to a third node, which is a base station in the NR mode, and the third node requests the UE to report the logged measurement result. Alternatively, in different scenarios, the third node may be a UE, a base station, a dual-connectivity primary base station, a dual-connectivity secondary base station, a core network node.
knowing that the logged measurement result exists and the signaling-based logged configuration exists through the first indication information, and/or the second indication information, and/or the access network technology indication information, then the second node does not configure another MDT, at least not the management-based logged MDT.
knowing that the logged measurement result does not exist and the signaling-based logged configuration exists through the first indication information, and/or the second indication information, and/or the access network technology indication information, then the second node may configure another MDT.

The behaviors of the second node are not limited to the above operations.

When the third node receives the indication information, it may transmit a message to the second node, to request to get a logged measurement report.

The third node transmits a message to inform the second node that the third node has obtained the logged measurement report of the UE.

The third node may be a UE, a base station, a dual-connectivity primary base station, a dual-connectivity secondary base station, a core network node.

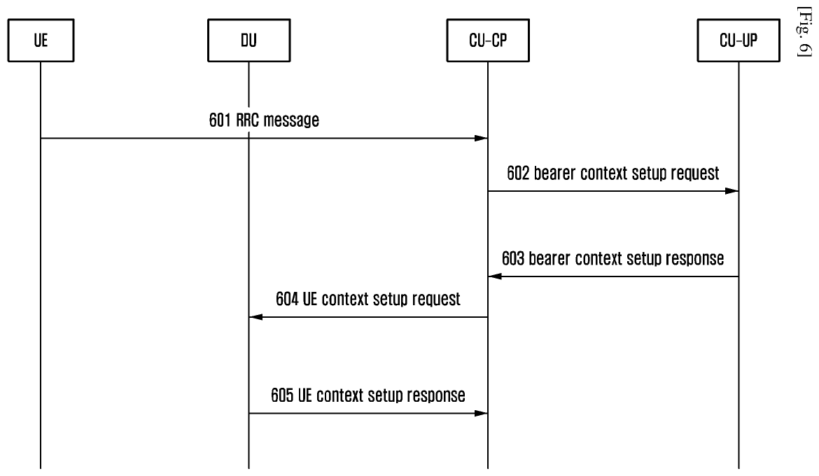

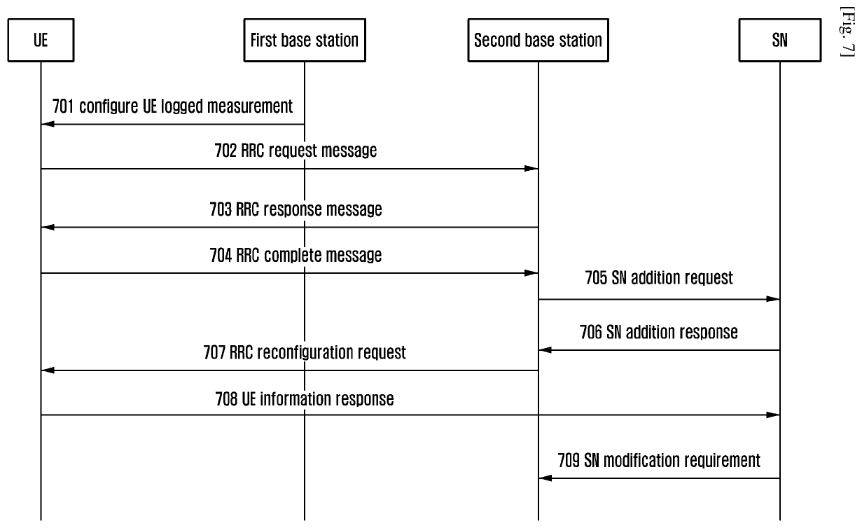

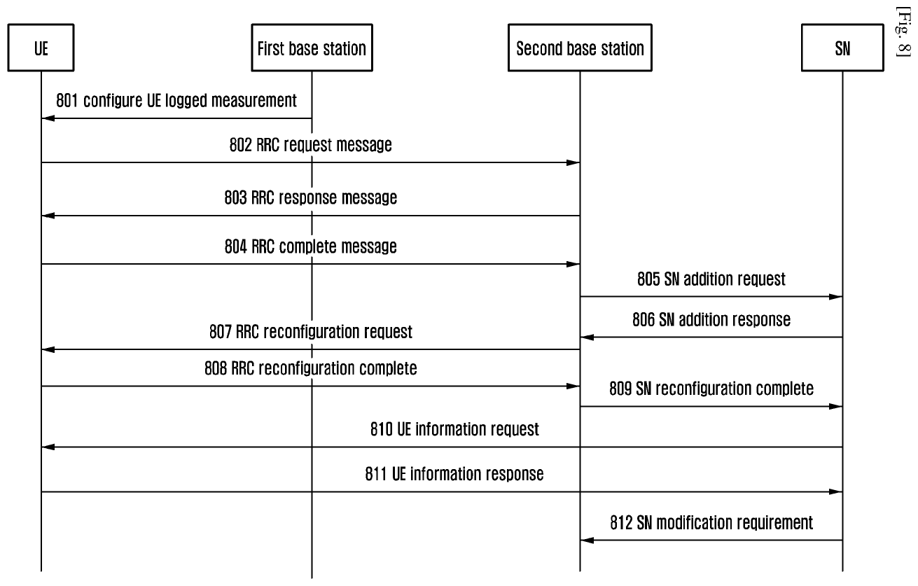

Next, FIG. 5 illustrates a flowchart of a method according to Embodiment 1 of the present disclosure, FIG. 6 illustrates a flowchart of a method according to Embodiment 2 of the present disclosure, FIG. 7 illustrates a flowchart of a method according to Embodiment 3 of the present disclosure, and FIG. 8 illustrates a flowchart of a method according to Embodiment 4 of the present disclosure. Herein, some steps in Embodiments 1 to 4 may be omitted, or other steps may be added. Further, Embodiments 1 to 4 may be implemented individually or in combination with each other.

### Embodiment 1

Embodiment 1 describes a method for MDT enhancement. A 5G base station has two access modes, one is an NR access mode, the other is an EUTRA access mode, and an LTE base station has one access mode, namely EUTRA access mode. A UE moves from a base station in one mode to a base station in another mode, which is called inter-RAT movement or handover. The embodiment describes a method for MDT enhancement in which the UE performs inter-RAT movement. According to the method of the embodiment, the base station can know an MDT configuration of the UE and/or an MDT report saved by the UE, so as to prevent MDT configured by the base station from covering the existing MDT configuration of the UE, and the base station can obtain an MDT measurement report in time, thus improving the possibility of configuring the MDT again by the base station.

Step 501: a first base station configures the UE for logged MDT measurement.

In the embodiment, the first base station may be an LTE base station, a base station in an EUTRA mode of a 5G system, or a base station in an NR mode of a 5G system, and the method is also applicable to base stations of other access systems.

If the first base station is the LTE base station, the UE accesses an LTE system, and is configured with signaling-based logged MDT measurement by a first base station in the LTE system.

If the first base station is the base station in the NR mode, or the base station in the EUTRA mode of the 5G system, the UE accesses a 5G system, and is configured with signaling-based logged MDT measurement by a base station of the 5G system.

After that, the UE enters an idle mode or an inactive mode, and the UE starts the logged MDT measurement. If the UE selects a cell with better signal quality due to the movement of the UE or degradation of cell signals under the first base station, the UE chooses to access a second base station according to a principle of cell reselection.

Step 502: the UE establishes an RRC connection with the second base station, and the UE transmits an RRC request message to the second base station.

In the embodiment, the second base station may be a base station in an EUTRA mode of a 5G system or a base station in an NR mode of a 5G system, and the method is also applicable to base stations of other access systems.

In this step, the RRC message may be an RRC connection setup request message, an RRC setup request, an RRC reestablishment request message, an RRC connection recovery request message, an RRC recovery request message, etc.

The RRC message includes an identifier of the UE and a reason for transmitting the RRC message.

Step 503: the second base station transmits an RRC message to the UE, for example, an RRC response message to the UE.

According to the RRC message in step 502, the RRC message in this step may be an RRC connection setup message, an RRC setup message, an RRC reestablishment message, an RRC connection recovery message, an RRC recovery message, or other messages.

The RRC message in this step includes configuration information of a radio bearer, configuration information of a cell group, etc.

Step 504: the UE transmits an RRC message to the second base station, for example, an RRC complete message to the second base station.

According to the messages in steps 502 and 503, the RRC message in this step may be an RRC connection setup success message, an RRC setup complete message, an RRC reestablishment complete message, an RRC connection recovery complete message, an RRC recovery complete message, an RRC reconfiguration complete message, etc. The RRC message includes information such as a service operator identifier PLMN ID selected by the UE, information of a registered core network access and mobility function entity AMF, a non-access stratum message, a temporary identifier allocated by the core network for the UE, etc.

The first base station and the second base station are base stations with different access technologies (or access modes, which may be used interchangeably herein). For example, the first base station is a first access mode and the second base station is a second access mode. The first and second access modes may be one of EUTRA, NR or other access modes. The UE is configured with a signaling-based logged MDT measurement configuration under the first base station, and the UE may carry the first indication information in the RRC message transmitted to the second base station. The first indication information may indicate whether the signaling-based logged MDT is configured, and further, it may indicate in which mode the UE is configured with the signaling-based logged MDT. In addition, the UE may carry second indication information in the RRC message transmitted to the second base station. The second indication information may indicate whether the logged MDT measurement is saved, and further, it may indicate which mode of the logged MDT measurement is saved.

According to the received information, the second base station may decide not to select the UE for logged MDT measurement, to avoid covering the logged MDT measurement configured by the first base station. Alternatively, the base station may select the UE for logged MDT measurement. In addition, the UE may also carry access network technology indication information in the RRC message transmitted to the second base station.

Specifically, the RRC message also includes one or more of the following information:
indication information of MDT logged measurement result existence. The RRC message carrying this information means that the UE terminal saves the measurement result, and if it does not carry this information, it means that the UE terminal does not save the measurement result.
indication information of signaling-based logged MDT measurement configuration existence. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
access mode indication information, which may be set to one of EUTRA and NR, or to one of LTE, 5G-NR and 5G-EUTRA. The access mode indication information may be related to the indication information of signaling-based logged MDT measurement configuration existence, for example, the access mode indication is set to EUTRA, and the access mode indication information indicates that the above MDT measurement configuration is configured by a base station in an EUTRA access mode. The access mode indication information may be related to the indication information of MDT logged measurement result existence, for example, the access mode indication is set to EUTRA, and the access mode indication information indicates that the above MDT logged measurement result existence refers to MDT measurement result existence in the EUTRA access mode.
indication information of signaling-based logged MDT measurement configuration existence in E-UTRA mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of signaling-based logged MDT measurement configuration existence in NR mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence in E-UTRA mode. The RRC message carrying this information means that the UE terminal saves an MDT measurement result in the E-UTRA mode, and if it does not carry this information, it means that the UE terminal does not save the MDT measurement result in the E-UTRA mode.
indication information of MDT logged measurement result existence in NR mode. The RRC message carrying this information means that the UE terminal saves an MDT measurement result in the NR mode, and if it does not carry this information, it means that the UE terminal does not save the MDT measurement result in the NR mode.
time information indicating how long before a clock corresponding to MDT (e.g., T330) expires, or a time of the T330 clock.

For example, if the UE chooses to go to a cell in an NR mode from a cell in an EUTRA mode. The cell in the EUTRA mode configures the UE with the signaling-based logged MDT, and the UE has performed MDT measurement and saved the MDT measurement result in the EUTRA mode. The UE may include the indication information of the MDT logged measurement result existence in the E-UTRA mode and the indication information of the of the signaling-based logged MDT measurement configuration existence in the RRC message. An NR base station receives the above information, and knows that the UE terminal saves the MDT measurement according to the indication information and the UE is configured with the signaling-based logged MDT measurement, so the NR base station cannot select this UE for another MDT measurement. If the RRC message does not include the indication information of the MDT logged measurement result existence in the E-UTRA mode, but includes the indication information of the signaling-based logged MDT measurement configuration existence, the NR base station may decide to choose to configure this UE for another MDT measurement. Therefore, the UE does not have the MDT measurement result yet, and using another MDT to cover the existing MDT measurement configuration will not cause loss of measurement data.

Alternatively, in the above case, the UE may include the indication information of the signaling-based logged MDT measurement configuration existence in the RRC message. The NR base station receives the above information, and according to the indication information, the NR base station cannot select this UE for another MDT measurement. Further, if the UE includes the time information in the RRC message, the NR base station receives the time information, and it may decide whether this UE can be selected to configure another MDT measurement according to the time information. For example, according to an indication of time information, another MDT measurement can be configured for this UE after a clock corresponding to the MDT has expired.

Alternatively, in the above case, the UE may include the indication information of the signaling-based logged MDT measurement configuration existence and the access mode indication information in the RRC message, which may be set to EUTRA. The NR base station receives the above information, and knows that the UE is configured with the signaling-based logged MDT measurement in EUTRA according to the indication information, so the NR base station cannot select this UE for another MDT measurement.

If the NR base station knows that the UE terminal saves the measurement result in NR, it may proceed to step 505 and transmit a message to request the UE to transmit the measurement result of MDT.

Step 505: the second base station transmits an RRC message to the UE, to request the UE to report a measurement report of MDT. The message carries indication information, indicating the UE to report a logged measurement report.

If the base station is an NR base station and knows that the UE terminal saves a measurement result of MDT in an NR mode, the base station may transmit a UE information request to the UE, to request the UE to report the measurement report of MDT to the base station, or if the base station is an EUTRA base station and knows that the UE terminal saves a measurement result of MDT in an EUTRA mode, the base station may transmit a UE information request to the UE, to request the UE to report the measurement report of MDT to the base station. The base station then transmits it to an MDT server.

Step 506: the UE transmits an RRC message to the second base station, which carries the MDT measurement report.

### Embodiment 2

Embodiment 2 describes a method for MDT enhancement. The embodiment describes how to let each node of a separated architecture know an MDT configuration of a UE under the separated architecture, so as to prevent each node of a base station from choosing to configure the UE for MDT measurement and covering the existing MDT configuration or MDT measurement of the UE. The separated architecture of the embodiment is applicable to any one of the first node, the second node, and the third node, and the way in which a method is performed with the separated architecture is also applicable to any one of Embodiments 1 to 4.

Step 601: a Centralized Unit-Control Plane (CU-CP) receives an RRC message. The message carries the first indication information and/or the second indication information and/or the access network technology indication information.

The RRC message in this step may be the message of step 504 in Embodiment 1, and the description of the message is shown in step 504, which is omitted here.

Step 602: the CU-CP transmits a bearer context setup request message or a bearer context modification request message to a Centralized Unit-User Plane (CU-UP).

The message includes a UE identifier on E1, a CU-CP E1AP ID, a CU-UP E1AP ID, a service operator identifier PLMN ID, a list of data radio bearer information to be established or a list of PDU session resources to be established, an MDT operator identifier list, information included in the RRC message received according to step 601, and may also include the first indication information, and/or the second indication information, and/or the access network technology indication information. Specifically, the message includes one or more of the following information:
indication information of signaling-based logged MDT measurement configuration existence. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
access mode indication information, which may be set to one of EUTRA and NR, or to one of LTE, 5G-NR and 5G-EUTRA. The access mode indication information may be related to the indication information of signaling-based logged MDT measurement configuration existence, for example, the access mode indication is set to EUTRA, and the access mode indication information indicates that the above MDT measurement configuration is configured by a base station in an EUTRA access mode. The access mode indication information may be related to the indication information of MDT logged measurement result existence, for example, the access mode indication is set to EUTRA, and the access mode indication information indicates that the above MDT logged measurement result existence refers to MDT measurement result existence in the EUTRA access mode.
indication information of signaling-based logged MDT measurement configuration existence in E-UTRA mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of signaling-based logged MDT measurement configuration existence in NR mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
time information indicating how long before a clock corresponding to MDT (e.g., T330) expires, or a time of the T330 clock.

The CU-UP receives the above information and knows that the UE is configured with the signaling-based logged MDT measurement, so the CU-UP cannot select this UE for another MDT measurement.

Step 603: the CU-UP transmits a bearer context setup response message or a bearer context modification response message to the CU-CP.

The message includes the UE identifier on E1, the CU-CP E1AP ID, the CU-UP E1AP ID, a list of successfully established data radio bearers, or a list of successfully established PDU sessions.

Step 604: the CU-CP transmits a UE context setup request message or a UE context modification request message to a Distributed Unit (DU).

The message includes the service operator identifier PLMN ID, a cell identifier CGI, the list of data radio bearer information to be established, the MDT operator identifier list, the information included in the RRC message received according to step 601, the first indication information, and/or the second indication information, and/or the access network technology indication information. Specifically, the message may also include one or more of the following information:
indication information of signaling-based logged MDT measurement configuration existence. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
access mode indication information, which may be set to one of EUTRA and NR, or to one of LTE, 5G-NR and 5G-EUTRA. The access mode indication information may be related to the indication information of signaling-based logged MDT measurement configuration existence, for example, the access mode indication is set to EUTRA, and the access mode indication information indicates that the above MDT measurement configuration is configured by a base station in an EUTRA access mode. The access mode indication information may be related to the indication information of MDT logged measurement result existence, for example, the access mode indication is set to EUTRA, and the access mode indication information indicates that the above MDT logged measurement result existence refers to MDT measurement result existence in the EUTRA access mode.
indication information of signaling-based logged MDT measurement configuration existence in E-UTRA mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of signaling-based logged MDT measurement configuration existence in NR mode. For example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
time information indicating how long before a clock corresponding to MDT (e.g., T330) expires, or a time of the T330 clock.

The CU-UP receives the above information and knows that the UE is configured with the signaling-based logged MDT measurement, so the CU-UP cannot select this UE for another MDT measurement.

Step 605: the DU transmits a UE context setup response message or a UE context modification response message to the CU-CP.

The message includes the UE identifier on F1, a CU UE F1AP ID, a DU UE F1AP ID, and the list of successfully established data radio bearers.

### Embodiment 3

Embodiment 3 describes a method for MDT enhancement of a UE in dual connectivity. A 5G base station has two access modes, one is an NR access mode, and the other is an EUTRA access mode. The dual connectivity is used to configure a primary base station and a secondary base station for the UE. If the primary base station is a base station in the NR access mode, the secondary base station is a base station in the EUTRA access mode. Embodiment 2 describes that when the SN knows that the UE terminal saves an MDT measurement report under an LTE system or an MDT measurement report under the base station in the EUTRA mode in a 5G system, the SN may request to get the MDT measurement report. Another case is that the primary base station is a base station in the EUTRA access mode, and the SN is a base station in the NR access mode. When the secondary base station knows that the UE terminal saves an MDT measurement report in the NR access mode, the SN may request to get the MDT measurement report. After the secondary base station obtains the MDT measurement report, the primary base station or the secondary base station may transmit an MDT configuration to the UE, to make the UE perform new MDT measurement.

According to the method of the embodiment, the base station can know an MDT configuration of the UE and/or an MDT report saved by the UE, so as to prevent MDT configured by the base station from covering the existing MDT configuration of the UE, and the base station can obtain an MDT measurement report in time, thus improving the possibility of configuring the MDT again by the base station.

Step 701: a first base station configures the UE for logged MDT measurement.

In the embodiment, the first base station may be an LTE base station, a base station in an EUTRA mode of a 5G system, or a base station in an NR mode of a 5G system, and the method is also applicable to base stations of other access systems.

If the first base station is the LTE base station, the UE accesses an LTE system, and is configured with signaling-based logged MDT measurement by a first base station in the LTE system.

If the first base station is the base station in the NR mode, or the base station in the EUTRA mode of the 5G system, the UE accesses a 5G system, and is configured with signaling-based logged MDT measurement by a base station of the 5G system.

After that, the UE enters an idle mode or an inactive mode, and the UE starts the logged MDT measurement. If the UE selects a cell with better signal quality due to the movement of the UE or degradation of cell signals under the first base station, the UE chooses to access a second base station according to a principle of cell reselection.

Step 702: the UE establishes an RRC connection with the second base station, and the UE transmits an RRC message to the second base station, for example, an RRC request message to the second base station.

In the embodiment, the second base station may be a base station in an EUTRA mode of a 5G system or a base station in an NR mode of a 5G system, and the method is also applicable to base stations of other access systems.

The RRC message may be an RRC connection setup request message, an RRC setup request, an RRC reestablishment request message, an RRC connection recovery request message, an RRC recovery request message, etc.

The RRC message in this step includes an identifier of the UE and a reason for transmitting the RRC message.

Step 703: the second base station transmits an RRC message to the UE, for example, an RRC response message to the UE.

According to the RRC message in step 702, the RRC message in this step may be an RRC connection setup message, an RRC setup message, an RRC reestablishment message, an RRC connection recovery message, an RRC recovery message, or other messages.

The RRC message in this step includes configuration information of a radio bearer, configuration information of a cell group, etc.

Step 704: the UE transmits an RRC message to the second base station, for example, an RRC complete message to the second base station.

According to the messages in steps 702 and 703, the RRC message in this step may be an RRC connection setup complete message, an RRC setup complete message, an RRC reestablishment complete message, an RRC connection recovery complete message, an RRC recovery complete message, or other messages. The RRC message includes a service operator identifier PLMN ID selected by the UE, information of a registered core network access and mobility function entity AMF, a non-access stratum message, a temporary identifier allocated by the core network for the UE. The RRC message may also include the first indication information, and/or the second indication information, and/or the access network technology indication information. Specifically, the message also includes one or more of the following information:
indication information of signaling-based logged MDT measurement configuration existence, for example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence. The RRC message carrying this information means that the UE terminal saves the measurement result, and if it does not carry this information, it means that the UE terminal does not save the measurement result.
access mode indication information, which may be set to one of EUTRA and NR, or to one of LTE, 5G-NR and 5G-EUTRA. For example, the access mode indication information is set to EUTRA, and the access mode indication information indicates that the above MDT measurement configuration is configured by a base station in an EUTRA access mode, and/or the above logged measurement result is for the EUTRA access mode.
indication information of signaling-based logged MDT measurement configuration existence in E-UTRA mode, for example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence in E-UTRA mode. The RRC message carrying this information means that the UE terminal saves the measurement result, and if it does not carry this information, it means that the UE does not save the measurement result.
indication information of signaling-based logged MDT measurement configuration existence in NR mode, for example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence in NR mode. The RRC message carrying this information means that the UE terminal saves the measurement result, and if it does not carry this information, it means that the UE does not save the measurement result.
time information indicating how long before a clock corresponding to MDT (e.g., T330) expires, or a time of the T330 clock.

For example, if the UE chooses to go to a cell in an NR mode from a cell in an EUTRA mode. The cell in the EUTRA mode configures the UE with the signaling-based logged MDT, and the UE has performed MDT measurement and saved the MDT measurement result in the EUTRA mode, so the UE may include combinations of the following information in the RRC message in this step:
indication information of signaling-based logged MDT measurement configuration existence;
indication information of logged measurement result existence in E-UTRA mode, indication information of signaling-based logged measurement configuration existence;
indication information of logged measurement result existence in E-UTRA mode, indication information of signaling-based logged measurement configuration existence in E-UTRA mode;
indication information of signaling-based logged measurement configuration existence, access mode indication information.

An NR base station receives the above information, and according to the indication information, the NR base station knows that the UE is configured with the signaling-based logged MDT measurement, and the UE saves the measurement report of MDT, and when the NR base station knows that the measurement configuration and/or the measurement report is in the EUTRA mode, the NR base station cannot select this UE for another MDT measurement. The NR base station cannot request to get the MDT measurement report saved by the UE, because the MDT measurement report is in the EUTRA mode.

Similarly, if the UE chooses to go to a cell in an EUTRA mode from a cell in an NR mode, in the same way, the base station in the EUTRA mode can know that the UE is configured with the signaling-based logged MDT measurement, the UE saves the measurement report of MDT, and can know that the measurement configuration and/or the measurement report is in the NR mode, and the base station in the EUTRA mode cannot select this UE for another MDT measurement. The EUTRA base station cannot request to get the MDT measurement report saved by the UE, because the MDT measurement report is in the NR mode.

Step 705: the second base station decides to establish dual connectivity, and the second base station, as the primary base station MN, transmits an SN addition request message to the secondary base station SN.

The SN addition request message includes one or more of the following information:
indication information of signaling-based logged MDT measurement configuration existence, for example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence. The RRC message carrying this information means that the UE terminal saves the measurement result, and if it does not carry this information, it means that the UE terminal does not save the measurement result.
access mode indication information, which may be set to one of EUTRA and NR, or to one of LTE, 5G-NR and 5G-EUTRA. For example, the access mode indication information is set to EUTRA, and the access mode indication information indicates that the above MDT measurement configuration is configured by a base station in an EUTRA access mode, and/or the above logged measurement result is for the EUTRA access mode.
indication information of signaling-based logged MDT measurement configuration existence in E-UTRA mode, for example, the signaling-based logged MDT measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of MDT logged measurement result existence in E-UTRA mode. The RRC message carrying this information means that the UE terminal saves the measurement result, and if it does not carry this information, it means that the UE does not save the measurement result.
time information indicating how long before a clock corresponding to MDT (e.g., T330) expires, or a time of the T330 clock.

If the SN is a base station in an EUTRA mode and knows that the UE saves the MDT measurement result in the EUTRA mode, or if the SN is a base station in an NR mode and knows that the UE saves the MDT measurement result in the NR mode, the SN may request the UE to report the MDT result to the SN. The request may be transmitted through the message in step 706, or through another RRC process, for example, a UE information request is transmitted to the UE through the SN, to request the UE to transmit the measurement report of MDT to the SN. The UE information request carries indication information, indicating the UE to report a logged measurement report. The RRC message may be transmitted directly to the UE through a signaling radio bearer between the SN and the UE, or forwarded to the UE through the MN.

Step 706: the SN transmits an SN addition response to the MN.

The message carries indication information, indicating the UE to report the logged measurement report.

Step 707: the MN transmits an RRC reconfiguration request to the UE.

The message carries indication information, indicating the UE to report the logged measurement report.

Step 708: the UE transmits an RRC message to the SN, which may be transmitted directly to the SN or through the MN. The RRC message carries the MDT measurement report.

The RRC message may be a UE information response, and the message carries the logged measurement report. After receiving the report, the SN may transmit the report to an MDT server.

Step 709: the SN transmits a message to the MN, for example an SN modification requirement message, to inform the MN that the SN has obtained the MDT measurement report. The MN may, using it as a reference, decide whether the UE can be selected for another MDT measurement.

### Embodiment 4

Embodiment 4 describes a method for MDT enhancement of a UE in dual connectivity. A 5G base station has two access modes, one is an NR access mode, and the other is an EUTRA access mode. The dual connectivity is used to configure a primary base station and a secondary base station for the UE. The modes of the primary base station and the secondary base station may be the same or different. Embodiment 4 describes that the modes of the MN and the SN are different. If the MN is in the NR access mode and the SN is in the EUTRA access mode, when the SN knows that the UE terminal saves an MDT measurement report in EUTRA, the SN may request to get the MDT measurement report. Another case is that the primary base station is a base station in an EUTRA access mode, and the SN is a base station in an NR access mode, and when the SN knows that the UE saves an MDT measurement report in NR, the SN may request to get the MDT measurement report. After the secondary base station obtains the MDT measurement report, the primary base station or the secondary base station may select the UE, transmit an MDT configuration to the UE, and make the UE perform new MDT measurement. According to the method of the embodiment, the base station can know an MDT configuration of the UE and/or an MDT report saved by the UE, so as to prevent MDT configured by the base station from covering the existing MDT configuration of the UE, and in addition, the base station can obtain an MDT measurement report in time, thus improving the possibility of configuring the MDT again by the base station.

Step 801: a first base station configures the UE for logged MDT measurement.

In the embodiment, the first base station may be an LTE base station, a base station in an EUTRA mode of a 5G system, or a base station in an NR mode of a 5G system, and the method is also applicable to base stations of other access systems.

If the first base station is the LTE base station, the UE accesses an LTE system, and is configured with signaling-based logged MDT measurement by a first base station in the LTE system.

If the first base station is the base station in the NR mode, or the base station in the EUTRA mode of the 5G system, the UE accesses a 5G system, and is configured with signaling-based logged MDT measurement by a base station of the 5G system.

After that, the UE enters an idle mode or an inactive mode, and the UE starts the logged MDT measurement. If the UE selects a cell with better signal quality due to the movement of the UE or degradation of cell signals under the first base station, the UE chooses to access a second base station according to a principle of cell reselection.

Step 802: the UE establishes an RRC connection with the second base station, and the UE transmits an RRC request message to the second base station.

In the embodiment, the second base station may be a base station in an EUTRA mode of a 5G system, a base station in an NR mode of the 5G system, or an LTE base station, and the method is also applicable to base stations of other access systems.

The RRC message may be an RRC connection setup request message, an RRC setup request, an RRC reestablishment request message, an RRC connection recovery request message, an RRC recovery request message, etc.

The RRC message in this step includes an identifier of the UE and a reason for transmitting the RRC message.

Step 803: the second base station transmits an RRC message to the UE, for example, an RRC response message to the UE.

According to the RRC message in step 802, the RRC message in this step may be an RRC connection setup message, an RRC setup message, an RRC reestablishment message, an RRC connection recovery message, an RRC recovery message, or other messages.

The RRC message includes configuration information of a radio bearer, configuration information of a cell group, etc.

Step 804: the UE transmits an RRC message to the second base station, for example, an RRC complete message to the second base station.

According to the messages in steps 802 and 803, the RRC message in this step may be an RRC connection setup complete message, an RRC setup complete message, an RRC reestablishment completeg message, an RRC connection recovery complete message, an RRC recovery complete message, or other messages. The RRC message includes a service operator identifier PLMN ID selected by the UE, information of a registered core network access and mobility function entity AMF, a non-access stratum message, a temporary identifier allocated by the core network for the UE. The RRC message may also include the first indication information, and/or the second indication information, and/or the access network technology indication information. Specifically, the RRC message may also include one or more of the following information:
indication information of signaling-based logged measurement configuration existence, for example, the signaling-based logged measurement configuration existence is set to “True”, indicating that the UE has been configured with the signaling-based logged MDT measurement configuration, and an associated clock has not expired. The signaling-based logged MDT measurement configuration is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
indication information of logged measurement result existence. The RRC message carrying this information means that the UE saves an MDT measurement result and forms an MDT report.
access mode indication information, which may be set to one of EUTRA and NR, or to one of LTE, 5G-NR and 5G-EUTRA. For example, the access mode indication information is set to EUTRA, and the access mode indication information indicates that the above MDT measurement configuration is configured by a base station in an EUTRA access mode, and/or the above logged measurement is for the EUTRA access mode.
indication information of signaling-based logged measurement configuration existence in EUTRA mode, for example, the indication information is set to “True”, indicating that the UE has been configured with the signaling-based logged MDT measurement by a cell/base station in the EUTRA mode, and an associated clock has not expired. If the indication information is set to “False”, it indicates that the UE has been configured with the signaling-based logged MDT measurement by the base station in the EUTRA mode, and the associated clock has expired. Regardless of whether it is set to “True” or “False”, it indicates that UE is configured with the signaling-based logged MDT measurement by the base station in the EUTRA mode.
indication information of logged measurement result existence in EUTRA mode. The RRC message carrying this information means that the UE saves an MDT measurement result in an EUTRA mode, and if it does not carry this information, it means that the UE does not save the MDT measurement result in the EUTRA mode.
indication information of signaling-based logged measurement configuration existence in NR mode, for example, the indication information is set to “True”, indicating that the UE has been configured with the signaling-based logged MDT measurement by a cell/base station in an NR mode, and an associated clock has not expired. The indication information is set to “False”, indicating that the UE has been configured with the signaling-based logged MDT measurement by the cell/base station in the NR mode, and the associated clock has expired. Regardless of whether it is set to “True” or “False”, it indicates that the UE is configured with the signaling-based logged MDT measurement by the cell/base station in the NR mode.
indication information of logged measurement result existence in NR mode. The RRC message carrying this information means that the UE saves an MDT measurement result in the NR mode, and if it does not carry this information, it means that the UE does not save the MDT measurement result in the NR mode.
time information indicating how long before a clock corresponding to the logged MDT measurement (e.g., T330) expires, or a current time of the T330 clock.

If the UE chooses to go to a cell in an NR mode from a cell in an EUTRA mode. The cell in the EUTRA mode configures the UE with the signaling-based logged MDT, and the UE performs MDT measurement and saves the MDT measurement result in the EUTRA mode, so the UE may include one or more of the following combination information in the RRC message in this step, which is an example here, and does not exclude other combinations:
indication information of signaling-based logged measurement configuration existence;
indication information of signaling-based logged measurement configuration existence in EUTRA mode;
indication information of signaling-based logged measurement configuration existence, access mode indication information being set to EUTRA.

The NR base station receives the above information, and according to the indication information, the NR base station knows that the UE is configured with the signaling-based logged MDT measurement, and further, it can know that the measurement configuration is configured by the cell in the EUTRA mode, and the NR base station cannot select this UE for another MDT measurement.

Similarly, if the UE chooses to go to the cell in the EUTRA mode from the cell in the NR mode, the base station in the EUTRA mode can know that the UE is configured with the signaling-based logged MDT measurement, and further, it can know that the measurement configuration is configured by the cell in the NR mode, and the base station in the EUTRA mode cannot select this UE for another MDT measurement.

Step 805: the second base station decides to establish dual connectivity, and the second base station, as the primary base station MN, transmits an SN addition request message to the secondary base station SN.

The SN addition request message includes data radio bearer information to be established, PDU session information to be established, and UE capability information. The message also includes one or more of the following information:
indication information of signaling-based logged measurement configuration existence, for example, the indication information is set to “True”, indicating that the UE has been configured with the signaling-based logged MDT measurement configuration, and an associated clock has not expired. The indication information is set to “False”, indicating that the UE has been configured with the signaling-based logged MDT measurement configuration, and the associated clock has expired. Regardless of whether it is set to “True” or “False”, it indicates that the UE is configured with the signaling-based logged MDT measurement.
access mode indication information, which may be set to one of EUTRA and NR, or to one of LTE, 5G-NR and 5G-EUTRA. For example, the access mode indication information is set to EUTRA, and the access mode indication information indicates that the above logged measurement configuration is configured by a base station in an EUTRA access mode.
indication information of signaling-based logged measurement configuration existence in EUTRA mode, for example, the indication information is set to “True”, indicating that the UE has been configured with the signaling-based logged MDT measurement configuration by a cell in an EUTRA mode, and an associated clock has not expired. The indication information is set to “False”, indicating that the UE has been configured with the signaling-based logged MDT measurement configuration by the cell in the EUTRA mode, and the associated clock has expired. Regardless of whether it is set to “True” or “False”, it indicates that the UE is configured with the signaling-based logged MDT measurement by the cell in the EUTRA mode.
indication information of signaling-based logged measurement configuration existence in NR mode. For example, the indication information is set to “True”, indicating that the UE has been configured with the signaling-based logged MDT measurement configuration by a cell in an NR mode, and an associated clock has not expired. The indication information is set to “False”, indicating that the UE has been configured with the signaling-based logged MDT measurement configuration by the cell in the NR mode, and the associated clock has expired. Regardless of whether it is set to “True” or “False”, it indicates that the UE is configured with the signaling-based logged MDT measurement by the cell in the NR mode.
time information indicating how long before a clock corresponding to the logged MDT measurement (e.g., T330) expires, or a current time of the T330 clock.

The SN base station receives the SN addition request message, and according to the above information included, the SN knows that the UE is configured with the signaling-based logged MDT measurement, and the SN cannot select this UE for another MDT measurement.

Step 806: the SN transmits an SN addition request acknowledge message to the MN.

The message carries RRC message/information related to configuration of radio resources of the UE by the SN, and the RRC message/information is transmitted to the MN through the SN addition request acknowledge message. The MN is not required to modify the content and forwards it to the UE.

Step 807: the MN transmits an RRC reconfiguration request message to the UE.

The RRC reconfiguration request message carries RRC message/information related to the radio resources of the UE configured by the SN, and also carries radio resources configured by the MN for the UE.

Step 808: the UE transmits an RRC reconfiguration complete message to the MN.

The message carries the RRC reconfiguration complete message to be transmitted to the SN, and the MN may include the RRC reconfiguration complete message to be transmitted to the SN in an RRC container without parsing the message, and transmit it to the SN through step 809. The RRC reconfiguration complete message to be transmitted to the SN may contain indication information related to MDT, and the indication information may be one or more of:
indication information of signaling-based logged measurement configuration existence, for example, the indication information is set to “True”, indicating that the UE has been configured with the signaling-based logged MDT measurement, and an associated clock has not expired. The indication information is set to “False”, indicating that the UE has been configured with the signaling-based logged MDT measurement, and the associated clock has expired. Regardless of whether it is set to “True” or “False”, it indicates that the UE is configured with the signaling-based logged MDT measurement.
indication information of logged measurement result existence. Carrying this information means that the UE saves the measurement result, and if this information is not carried, it means that the UE does not save the measurement result.
access mode indication information, which may be set to one of EUTRA and NR, or to one of LTE, 5G-NR and 5G-EUTRA. For example, the access mode indication information is set to EUTRA, and the access mode indication information indicates that the above MDT measurement configuration is configured by a base station in an EUTRA access mode, and/or the above logged measurement result is for the EUTRA access mode.
indication information of logged measurement result existence in EUTRA mode. Carrying this information means that the UE saves the MDT measurement result in EUTRA, and if this information is not carried, it means that the UE does not save the MDT measurement result in EUTRA.
indication information of logged measurement results in NR mode. Carrying this information means that the UE saves the MDT measurement result in NR, and if this information is not carried, it means that the UE does not save the MDT measurement result in NR.
indication information of signaling-based logged measurement configuration existence in EUTRA mode, for example, the indication information is set to “True”, indicating that the UE has been configured with the signaling-based logged MDT measurement configuration by a cell in an EUTRA mode, and an associated clock has not expired. The indication information is set to “False”, indicating that the UE has been configured with the signaling-based logged MDT measurement configuration by the cell in the EUTRA mode, and the associated clock has expired. Regardless of whether it is set to “True” or “False”, it indicates that the UE is configured with the signaling-based logged MDT measurement by the cell in the EUTRA mode.
indication information of signaling-based logged measurement configuration existence in NR mode. For example, the indication information is set to “True”, indicating that the UE has been configured with the signaling-based logged MDT measurement configuration by a cell in an NR mode, and an associated clock has not expired. The indication information is set to “False”, indicating that the UE has been configured with the signaling-based logged MDT measurement configuration by the cell in the NR mode, and the associated clock has expired. Regardless of whether it is set to “True” or “False”, it indicates that the UE is configured with the signaling-based logged MDT measurement by the cell in the NR mode.
time information indicating how long before a clock corresponding to the logged MDT measurement (e.g., T330) expires, or a current time of the T330 clock.

Step 809: the MN transmits an SN reconfiguration complete message to the SN.

The SN reconfiguration complete message carries the RRC reconfiguration complete message received from the UE and transmitted to SN, that is, the information described in step 808 is carried.

The information described in step 808 may also be transmitted from the UE to the SN through another RRC message. If there is a direct signaling radio bearer between the UE and the SN, the another RRC message may be transmitted from the UE to the SN through the direct signaling radio bearer, or forwarded to the SN through the MN. The main content carried by the another RRC message is shown in step 808.

Step 810: the SN transmits an RRC message to the UE, which may be a UE information request or other messages.

When the SN knows that UE saves the MDT measurement result, the SN may request the UE to transmit the MDT measurement report to the SN. The RRC message in step 810 carries the indication information to indicate the UE to report the logged measurement report. The RRC message may be transmitted directly to the UE by the SN through the signaling radio bearer between the SN and the UE, or forwarded to the UE through the MN.

Step 811: the UE transmits an RRC message to the SN, which carries the MDT measurement report.

The RRC message may be a UE information response, and the message carries the logged measurement report. After receiving the report, the SN may transmit the report to an MDT server. The RRC message may be transmitted directly to the SN by the UE through the signaling radio bearer between the SN and the UE, or forwarded to the SN through the MN.

Step 812: the SN transmits a message to the MN, for example an SN modification requirement message, to inform the MN that the SN has obtained the MDT measurement report. The MN may, using it as a reference, decide whether the UE can be selected for another MDT measurement.

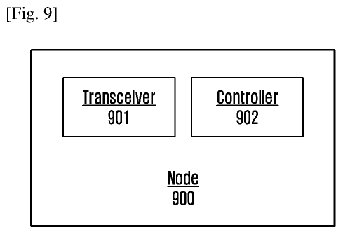

FIG. 9 illustrates a block diagram of a configuration of a node 900 according to various embodiments of the present disclosure. The node 900 may include any one of the first node, the second node and the third node.

Referring to FIG. 9, a node 900 according to various embodiments of the present disclosure may include a transceiver 901 and a controller 902. For example, the transceiver 901 may be configured to transmit and receive signals. For example, the controller 902 may be coupled to the transceiver 901 and configured to perform the aforementioned methods.

While the node is illustrated as having separate functional blocks for convenience of explanation, the configuration of the node is not limited thereto. For example, the node may include a communication unit consisting of a transceiver and a controller. The node may communicate with at least one network node by means of the communication unit.

According to embodiments of the present disclosure, at least part of the nodes (e.g., modules or functions thereof) or the methods (e.g., operations or steps) may be implemented by instructions which are stored in a computer-readable storage medium (e.g., the memory) in a form of a program module. When executed by a processor or controller, the instructions may enable the processor or controller to perform corresponding functions. The computer-readable medium may include, for example, a hard disk, a floppy disk, a magnetic media, an optical recording media, a DVD, a magneto-optical media, and the like. The instructions may include codes made by a compiler or codes which can be executed by an interpreter. The modules or the UE according to various embodiments of the present disclosure may include at least one or more of the aforementioned components, omit some of the aforementioned components, or further include other additional components. The operations executed by the modules, program modules, or other components according to various embodiments of the present disclosure may be executed sequentially, parallelly, repeatedly, or heuristically. Alternatively, at least some operations may be executed in different orders or may be omitted, or other operations may be added.

What has been described above are only example embodiments of the present invention, and are not intended to limit the scope of protection of the present invention, which is determined by the appended claims.

1-15. (canceled)

16. A method performed by a second node in a communication system, the method comprising:
receiving, from a first node, a radio resource control (RRC) message including at least one of first indication information indicating whether a minimization of drive tests (MDT) measurement result exists, second indication information indicating whether a MDT measurement configuration exists or third indication information indicating an access network technology.

17. The method of claim 16,
wherein the first indication information indicates at least one of a logged measurement result existing, a logged measurement result in a first access mode existing, or a logged measurement result in a second access mode existing, and
wherein the second indication information indicates at least one of a signaling-based logged configuration existing, a management-based logged configuration existing, a signaling-based logged configuration in a first access mode existing, a management-based logged configuration in the first access mode existing, a signaling-based logged configuration in a second access mode existing, or a management-based logged configuration in the second access mode existing.

18. The method of claim 16,
wherein in case that at least one of the first indication information, the second indication information or the third indication information indicates that a logged measurement result in a first access mode exists and a signaling-based logged configuration in the first access mode exists, if the second node is the node in the second access mode, another MDT not being configured, and
wherein in case that at least one of the first indication information, the second indication information or the third indication information indicates that the logged measurement result in the first access mode does not exist and the signaling-based logged configuration in the first access mode exists, in case that the second node is the node in the second access mode, another MDT being configured,
wherein the third indication information indicates at least one of long term evolution (LTE) technology, evolved universal mobile telecommunications system (UMTS) terrestrial radio access (EUTRA), fifth generation (5G) communication technology and new radio (NR) access technology.

19. The method of claim 16, further comprising:
transmitting, by a centralized unit-control plane (CU-CP), a first request message to a centralized unit-user plane (CU-UP), wherein the first request message includes the at least one indication information;
transmitting, by the CU-UP, a first response message to the CU-CP;
transmitting, by the CU-CP, a second request message to a distributed unit (DU), wherein the second request message includes the at least one indication information; and
transmitting, by the DU, a second response message to the CU-CP,
wherein the second node and/or a third node includes the CU-CP, the CU-UP and the DU, and the receiving of the at least one indication information comprises receiving, by the CU-CP, the at least one indication information.

20. A method performed by a third node in a communication system, the method comprising:
receiving, from a first node, at least one of first indication information indicating whether a minimization of drive tests (MDT) measurement result exists,, second indication information indicating whether a MDT measurement configuration exists or third indication information indicating an access network technology,
transmitting, to the first node, a first RRC message to request the first node to report a logged measurement result; and
receiving, from the first node, a second RRC message including the logged measurement result.

21. The method of claim 20,
wherein the first indication information indicates at least one of a logged measurement result existing, a logged measurement result in a first access mode existing, or a logged measurement result in a second access mode existing,
wherein the second indication information indicates at least one of a signaling-based logged configuration existing, a management-based logged configuration existing, a signaling-based logged configuration in a first access mode existing, a management-based logged configuration in the first access mode existing, a signaling-based logged configuration in a second access mode existing, or a management-based logged configuration in the second access mode existing, and
wherein the third indication information indicates at least one of long term evolution (LTE) technology, evolved universal mobile telecommunications system (UMTS) terrestrial radio access (EUTRA), fifth generation (5G) communication technology and new radio (NR) access technology.

22. The method of claim 20,
wherein the at least one indication information is received from the second node through a secondary base station addition request message or through a radio resource control (RRC) container, wherein the RRC container includes at least one of the first indication information, the second indication information and the third indication information.
wherein the first RRC message is transmitted directly to the first node through a signaling radio bearer or forwarded to the first node through the second node, and
wherein the second RRC message is received directly from the first node through a signaling radio bearer, or the second RRC message is received from the second node, wherein the second RRC message is received by the second node from the first node.

23. The method of claim 21, further comprising:
transmitting, by a centralized unit-control plane (CU-CP), a first request message to a centralized unit-user plane (CU-UP), wherein the first request message includes the at least one indication information;
transmitting, by the CU-UP, a first response message to the CU-CP;
transmitting, by the CU-CP, a second request message to a distributed unit (DU), wherein the second request message includes the at least one indication information; and
transmitting, by the DU, a second response message to the CU-CP,
wherein the second node and/or the third node includes the CU-CP, the CU-UP and the DU and the receiving of the at least one indication information comprises receiving, by the CU-CP, the at least one indication information, and wherein the method further comprises.

24. A second node in a communication system, the second node comprising:
a transceiver configured to transmit and receive signals; and
a controller coupled with the transceiver, the controller configured to:
receive, from a first node, a radio resource control (RRC) message including at least one of first indication information indicating whether a minimization of drive tests (MDT) measurement result exists, second indication information indicating whether a MDT measurement configuration exists or third indication information indicating an access network technology.

25. The second node of claim 24,
wherein the first indication information indicates at least one of a logged measurement result existing, a logged measurement result in a first access mode existing, or a logged measurement result in a second access mode existing, and
wherein the second indication information indicates at least one of a signaling-based logged configuration existing, a management-based logged configuration existing, a signaling-based logged configuration in a first access mode existing, a management-based logged configuration in the first access mode existing, a signaling-based logged configuration in a second access mode existing, or a management-based logged configuration in the second access mode existing.

26. The second node of claim 24,
wherein in case that at least one of the first indication information, the second indication information or the third indication information indicates that a logged measurement result in a first access mode exists and a signaling-based logged configuration in the first access mode exists, if the second node is the node in the second access mode, another MDT not being configured, and
wherein in case that at least one of the first indication information, the second indication information or the third indication information indicates that the logged measurement result in the first access mode does not exist and the signaling-based logged configuration in the first access mode exists, in case that the second node is the node in the second access mode, another MDT being configured,
wherein the third indication information indicates at least one of long term evolution (LTE) technology, evolved universal mobile telecommunications system (UMTS) terrestrial radio access (EUTRA), fifth generation (5G) communication technology and new radio (NR) access technology.

27. The second node of claim 24, wherein the controller is further configured to:
transmit, by a centralized unit-control plane (CU-CP), a first request message to a centralized unit-user plane (CU-UP), wherein the first request message includes the at least one indication information;
transmit, by the CU-UP, a first response message to the CU-CP;
transmit, by the CU-CP, a second request message to a distributed unit (DU), wherein the second request message includes the at least one indication information; and
transmit, by the DU, a second response message to the CU-CP,
wherein the second node and/or the third node includes the CU-CP, the CU-UP and the DU, and the receiving of the at least one indication information comprises receiving, by the CU-CP, the at least one indication information.

28. A third node in a communication system, the third node comprising:
a transceiver configured to transmit and receive signals; and
a controller coupled with the transceiver, the controller configured to:
receive, from a first node, at least one of first indication information indicating whether a minimization of drive tests (MDT) measurement result exists,, second indication information indicating whether a MDT measurement configuration exists or third indication information indicating an access network technology,
transmit, to the first node, a first RRC message to request the first node to report a logged measurement result; and
receive, from the first node, a second RRC message including the logged measurement result.

29. The third node of claim 28,
wherein the first indication information indicates at least one of a logged measurement result existing, a logged measurement result in a first access mode existing, or a logged measurement result in a second access mode existing,
wherein the second indication information indicates at least one of a signaling-based logged configuration existing, a management-based logged configuration existing, a signaling-based logged configuration in a first access mode existing, a management-based logged configuration in the first access mode existing, a signaling-based logged configuration in a second access mode existing, or a management-based logged configuration in the second access mode existing, and
wherein the third indication information indicates at least one of long term evolution (LTE) technology, evolved universal mobile telecommunications system (UMTS) terrestrial radio access (EUTRA), fifth generation (5G) communication technology and new radio (NR) access technology.

30. The third node of claim 28,
wherein the at least one indication information is received from the second node through a secondary base station addition request message or through a radio resource control (RRC) container, wherein the RRC container includes at least one of the first indication information, the second indication information and the third indication information.
wherein the first RRC message is transmitted directly to the first node through a signaling radio bearer or forwarded to the first node through the second node, and
wherein the second RRC message is received directly from the first node through a signaling radio bearer, or the second RRC message is received from the second node, wherein the second RRC message is received by the second node from the first node.

31. The third node of claim 29, wherein the controller is further configured to:
transmit, by a centralized unit-control plane (CU-CP), a first request message to a centralized unit-user plane (CU-UP), wherein the first request message includes the at least one indication information;
transmit, by the CU-UP, a first response message to the CU-CP;
transmit, by the CU-CP, a second request message to a distributed unit (DU), wherein the second request message includes the at least one indication information; and
transmit, by the DU, a second response message to the CU-CP,
wherein the second node and/or the third node includes the CU-CP, the CU-UP and the DU and the receiving of the at least one indication information comprises receiving, by the CU-CP, the at least one indication information.
